(19) United States
(12) Patent Application Publication
(10) Pub. No.: US 2025/0088361 A1
(43) Pub. Date: Mar. 13, 2025

(54) TRUSTED PLATFORM MODULE DEVICE FOR MULTI-NODE SYSTEMS

(71) Applicant: Intel Corporation, Santa Clara, CA (US)

(72) Inventors: Samuel HUI, Hillsboro, OR (US); Jayant MANGALAMPALLI, Corcoran, MN (US); Fulton LI, Camas, WA (US); Ching Yu LO, Portland, OR (US)

(21) Appl. No.: 18/954,131

(22) Filed: Nov. 20, 2024

(51) Int. Cl. H04L 9/32; H04L 9/08

(52) U.S. Cl. CPC H04L 9/3234; H04L 9/0819; H04L 9/3226; H04L 9/3247; H04L 9/3263

(57) ABSTRACT

Examples described herein relate to an apparatus comprising: multiple processors and circuitry coupled to the multiple processors, wherein at least one of the multiple processors comprises multiple cores and wherein the circuitry is to provide the multiple processors with access to at least two firmware Trusted Platform Module (TPM) instances. At least two firmware TPM instances of the firmware TPM instances is to apply cryptography to store information for platform authentication and wherein the information for platform authentication comprises one or more of: user credentials, passwords, certificates, encryption keys, shared secrets, state information, or hash data.

### BACKGROUND

Datacenters utilize computer systems with processors to process and generate data for purposes such as electronic commerce, media streaming, image detection and recognition, and others. On a computer system, a Trusted Platform Module (TPM) is a physical or embedded security microcontroller. TPMs use cryptography to securely store critical information utilized during platform authentication. As a number of computer systems increase, the number of TPMs increase. However, cost, physical space, and input output (IO) pin constraints may limit the number of TPMs and correspondingly, limit the number of computer systems.

### BRIEF DESCRIPTION OF THE DRAWINGS

FIG. 1 depicts an example system.

FIG. 2 depicts an example system.

FIG. 3 depicts an example system.

FIG. 4A depicts an example process.

FIG. 4B depicts an example process.

FIG. 5 depicts an example system.

### DETAILED DESCRIPTION

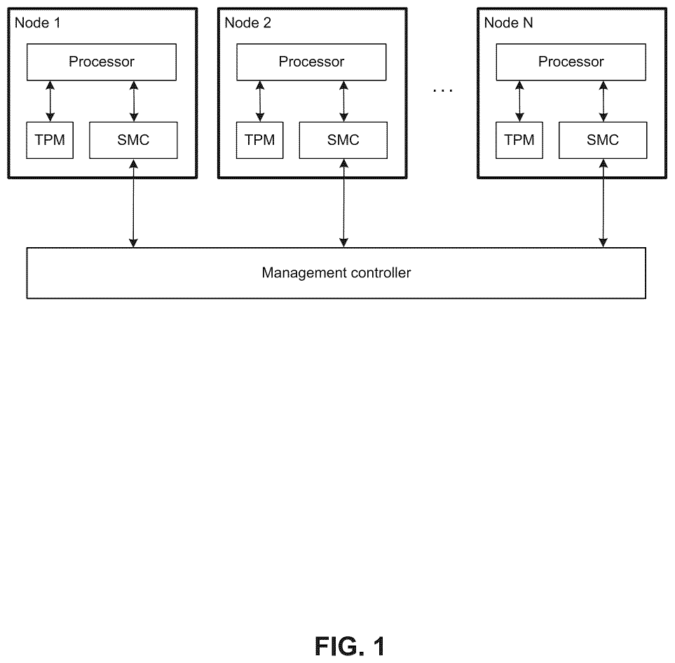

FIG. 1 shows an example multi-node system design. One discrete TPM is allocated to each compute node 1 to N, where N is an integer. However, use of a discrete TPM per node may not scale as the number of nodes increases due to cost, physical space, and interface constraints to provide a TPM for each node.

Various examples can reduce a number of TPMs utilized by a multi-node system and utilize N number of discrete TPMs for M number of compute nodes, where N<M. For example, a single device (e.g., a management controller, accelerator, network interface device, or other device) can implement multiple TPM instances as firmware instances such as one firmware TPM instance for a particular compute node. A multi-node system can utilize a single management controller that implements multiple firmware TPMs instead of utilizing multiple discrete TPMs. In some examples, a node can utilize an interface device (e.g., satellite management controller (SMC)) to access an associated firmware TPM.

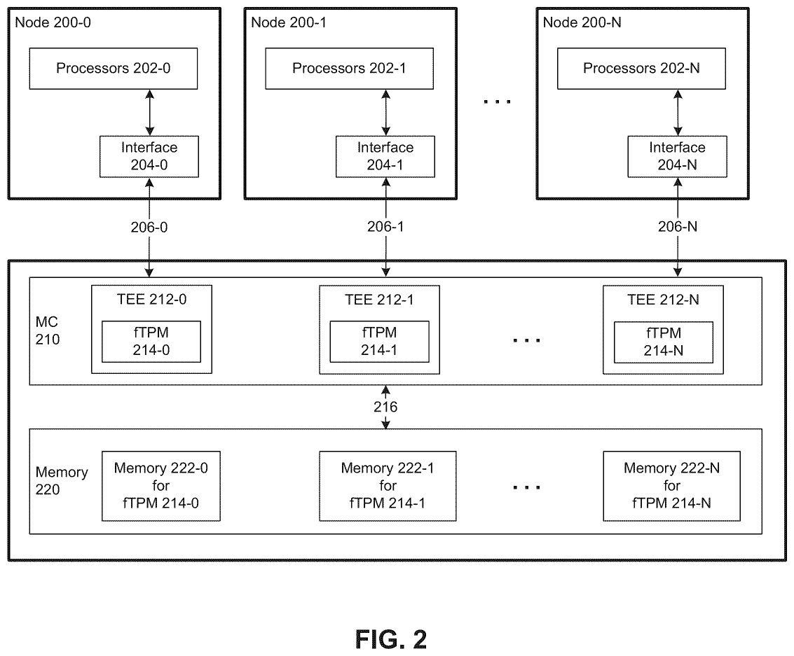

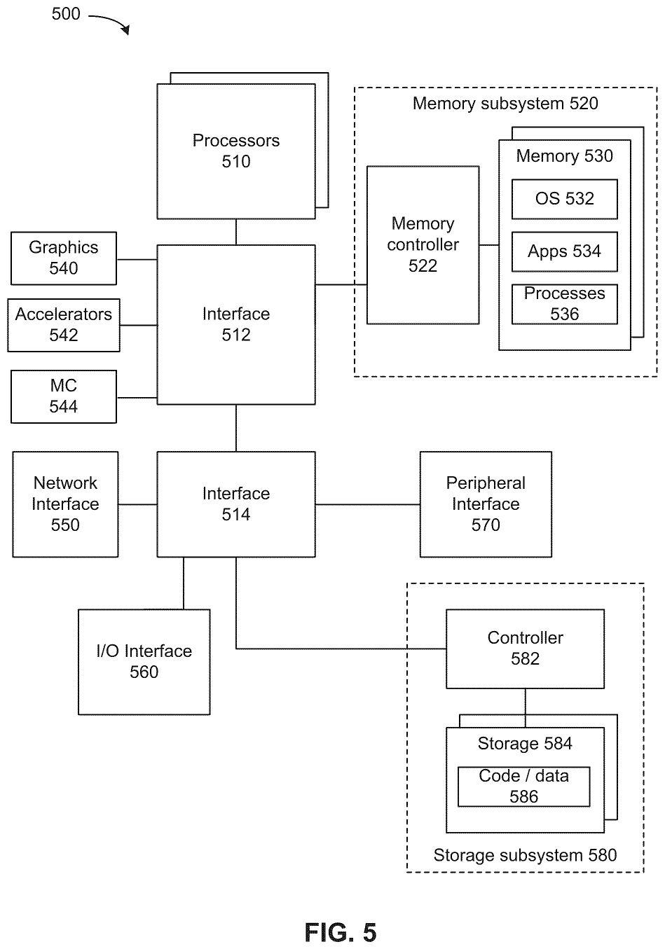

FIG. 2 depicts an example system. Nodes 200-0 to 200-N can include associated processors 202-0 to 202-N and interfaces 204-0 to 204-N, where N is an integer, as well as silicon firmware and other software or circuitry described at least with respect to FIG. 5. In some examples, one or more of nodes 200-0 to 200-N can include a cover that is made of plastic and can include metal contacts for pins or lands of processors 202-0 to 202-N. A processor socket can include a ball grid array (BGA), Pin Grid Array (PGA), Land Grid Array (LGA), or other interface that can couple a processor (e.g., processors 202-0 or 202-N) to a circuit board (e.g., printed circuit board (PCB)), without soldering the processor to the circuit board.

In some examples, nodes 200-0 to 200-N can include a physical package that includes one or more discrete dies or tiles connected by mesh or other connectivity as well as an interface (not shown) and heat dispersion (not shown). A die can include semiconductor devices that include one or more processing devices or other circuitry. A tile can include semiconductor devices that include one or more processing devices or other circuitry. For example, a physical package can include one or more dies, plastic or ceramic housing for the dies, and conductive contacts conductively coupled to a circuit board.

One or more of processors 202-0 to 202-N can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processors 202-0 to 202-N can be heterogeneous or homogeneous processor types where processors in different sockets are a same type (e.g., CPU, GPU, NPU, etc.) or different type (e.g., a first socket includes a CPU and a GPU and a second socket includes a GPU and an NPU).

Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores may be coupled via an interconnect to a system agent (uncore).

One or more of nodes 200-0 to 200-N can include a system agent. A system engine can include a shared cache which may include any type of cache (e.g., level 1, level 2, or last level cache (LLC)). A system agent can include one or more of: a memory controller, a shared cache, a cache coherency manager, arithmetic logic units, floating point units, core or processor interconnects, or bus or link controllers. A system agent or uncore can provide one or more of: direct memory access (DMA) engine connection, non-cached coherent master connection, data cache coherency between cores and arbitrate cache requests, or Advanced Microcontroller Bus Architecture (AMBA) capabilities. System agent or uncore can manage priorities and clock speeds for receive and transmit fabrics and memory controllers.

In some examples, nodes 200-0 to 200-N can access associated firmware TPM (fTPM) instances 212-0 to 212-N via respective interfaces 204-0 to 204-N. In some examples, one or more of interfaces 204-0 to 204-N can be implemented as a satellite management controller (SMC). A satellite management controller can provide a management application program interface (API) for processors 202-0 to 202-N to communicate with management controller (MC) 210. An SMC can include a microcontroller that executes a real time operating system (RTOS). An SMC can be based on OCP Satellite Management Controller Base Specification Revision 1.0, Version 1.0 (September 2023), as well as earlier and later versions or variations thereof.

In some examples, management controller 210 can perform management and monitoring capabilities for system administrators or orchestrators to manage and monitor operation at least of nodes 200-0 to 200-N and devices connected thereto, such as, a network interface device and storage device, using channels, including in-band channels and out-of-band channels. Out-of-band channels can include packet flows or transmission media that communicate metadata and telemetry. In some examples, management controller 210 can be implemented as one or more of: Baseboard Management Controller (BMC), Intel® Management or Manageability Engine (ME), or other devices.

A trusted computing base (TCB) can include system resources (e.g., hardware, firmware, and software) that maintains a security policy of one or more of nodes 200-0 to 200-N. The TCB can prevent itself from being compromised by hardware or software that is not part of the TCB. A firmware TPM (fTPM) can allow a node or other requester to determine if the TCB has been compromised. In some examples, the fTPM can prevent the system from starting if the TCB cannot be properly instantiated or issue an error message to a system administrator or orchestrator.

In some examples, management controller 210 can execute N separate instances of firmware TPM (fTPM) 214-0 to 214-N for one or more of nodes 200-0 to 200-N in respective Trusted Execution Environments (TEEs) 212-0 to 212-N. An example fTPM is described at least in Trusted Computing Group (TCG) “Trusted Platform Module Library Specification, Family 2.0,Level 00, Revision 01.83 (March 2024), as well as earlier and later versions or variations thereof. Management controller 210 can be implemented as an FPGA, ASIC, microcontroller, or other circuitry that executes fTPM instances in isolated TEEs. A number of fTPM instances can be configurable runtime based on number of nodes. Data in the TEE cannot be read or tampered with by processor-executed code outside the TEE such as other management controller services running outside of the TEE and fTPM instance TEEs for the other nodes.

A TEE can include a hardware-enforced segregated area of memory and processor that is protected from access using encryption. A TEE can provide a trust domain, confidential computing environment, or secure enclave that can be created using one or more of: total memory encryption (TME), multi-key total memory encryption (MKTME), Trusted Domain Extensions (TDX), Double Data Rate (DDR) encryption, function as a service (FaaS) container encryption or an enclave/TD (trust domain), Intel® SGX, Intel® TDX, AMD Memory Encryption Technology, AMD Secure Memory Encryption (SME) and Secure Encrypted Virtualization (SEV), AMD Secure Encrypted Virtualization-Secure Nested Paging (AMD SEV-SNP), ARM® TrustZone®, ARM® Realms and Confidential Compute, Apple Secure Enclave Processor, Qualcomm® Trusted Execution Environment, RISC-V Trusted Execution Environment (TEE), Distributed Management Task Force (DMTF) Security Protocol and Data Model (SPDM) specification, virtualization-based isolation such as Intel VTd and AMD-v, or others.

For example, one or more of interface devices 204-0 to 204-N can only access associated firmware TPM 214-0 to 214-N via respective interfaces 206-0 to 206-N. In some examples, interfaces 206-0 to 206-N can provide authenticated and encrypted communications based on Distributed Management Task Force (DMTF) Security Protocol and Data Model (SPDM) standard sessions. An SPDM communication channel between a node's processor and the fTPM with an authenticated and encrypted SPDM session can potentially thwart against interposer man-in-the-middle attacks. However, other communications standards can be used such as Peripheral Component Interconnect express (PCIe), Compute Express Link (CXL), universal asynchronous receiver/transmitter (UART), or others. Other encryption standards can be used such as Integrity and Data Encryption (IDE), Component Measurement and Authentication (CMA), Data Object Exchange (DOE), or other encryption technologies.

One or more of fTPMs 214-0 to 214-N can cryptographically secure and store platform authentication information of an associated node 200-0 to 200-N in memory 220. Platform authentication information can include: user credentials, passwords, certificates, encryption keys, shared secrets, state information, hash data, or other data. One or more of fTPMs 214-0 to 214-N can indicate firmware or software configurations of an associated node in hash data. One or more of fTPMs 214-0 to 214-N can use cryptographic keys to encrypt the platform authentication information prior to storage in memory 220. Memory 220 can include one or more of: non-volatile random-access memory (NVRAM) device, Universal Flash Storage (UFS), embedded multi-media cards (eMMCs), flash storage, or others. For example, a region of memory 222-0 in memory 220 can be allocated to store platform authentication information for fTPM 214-0, a region of memory 222-1 in memory 220 can be allocated to store platform authentication information for fTPM 214-1, and so forth.

Socket level partitioning allows a platform with multiple processor sockets to boot in a single system that executes a single operating system (OS) or multiple independent single socket systems that execute multiple operating systems. For example, in a non-partitioned mode, a two partition (2S) platform can operate as a single node, and resources connected to the two processor sockets are part of the single node. Processors (e.g., 202-0 to 202-N) in the non-partitioned mode, including software (e.g., OS or processes), can share resources such as connected memory, cores in different sockets, cache, connected input/output (I/O), device interface-connected devices (e.g., Peripheral Component Interconnect express (PCIe), Compute Express Link (CXL)) and other circuitry, firmware, or software. Processors in the non-partitioned mode can access memory in a coherent manner so that memory is shared among the processors.

For example, in a partitioned mode, a 2S platform can operate as two separate sockets and can operate in independent power states (e.g., S0, S5, and so on), perform separate error handling, and not share one or more of: connected memory, cores in different sockets, cache, isolated input/output (I/O) communication interfaces, or device interface-connected devices. Partitions can operate as separate coherent domains. Moreover, in partitioned mode, different socket partitions (e.g., 200-0 and 200-1) can independently power cycle, utilize different and independent clock signals, different partitions can utilize isolated in-band and out-of-band channels, different partitions can independently communicate with one or more management controllers, different partitions can utilize one or more debug ports, different partitions can independently utilize one or more root of trust devices that authenticate or validate different boot firmware, or others. Multiple processors (e.g., 202-0 and 202-1) can execute separate boot firmware code and handoff platform control to OSs executed by different processors. In a partitioned mode, peripheral or telemetry data may not be shared among different partitioned processor sockets, storage dependency may not be shared among different partitioned processor sockets, and so forth. In a partitioned mode, cross socket isolation can occur whereby sockets have independent power states. A catastrophic Reliability, Availability and Serviceability (RAS) event in a partition may not impact the run-time stability of another partitions.

For partitioned mode, bifurcation of resources (e.g., cache, memory, memory controllers, registers, processors, interfaces, physical layer interfaces, or others) among partitions may be equal or unequal and set based on service level agreement (SLA), service level objectives (SLO), application request, data center administrator configuration, or others.

In some examples, management controller 210 can be placed in top-of-rack switch, Edge network element, network interface device, or other devices. While examples are described with respect to management controller 210 executing fTPM for different nodes, instead of, or in addition to management controller 210, one or more of the following can execute fTPM for different nodes: a network interface device, accelerator, FPGA, ASIC, a processor, or other circuitry.

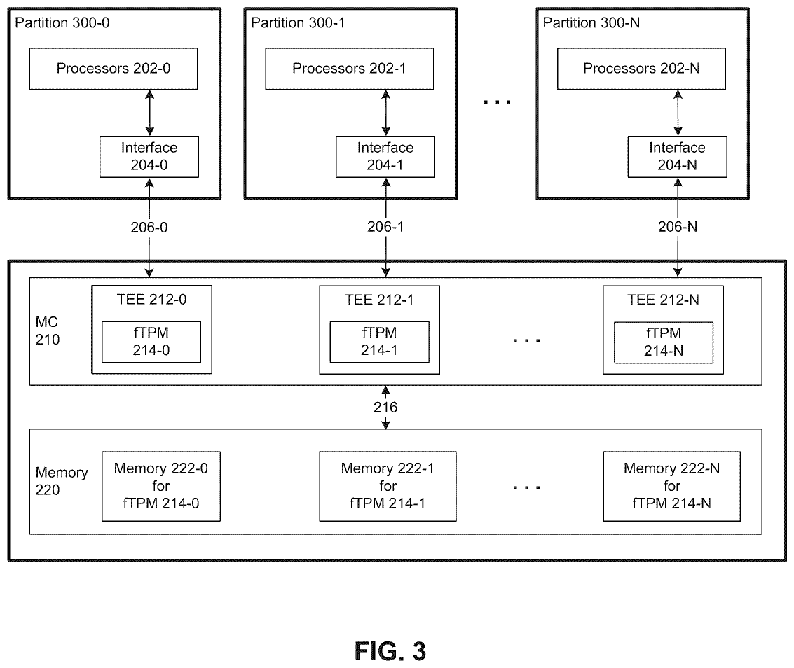

FIG. 3 depicts an example of allocation of socket partitions to fTPM. In some examples, an fTPM can be allocated to one or more socket partitions. For partitioning of a processor socket into multiple partitions 300-0 to 300-N, partitions 300-0 to 300-N can access associated fTPM 214-0 to 214-N via interfaces 204-0 to 204-N.

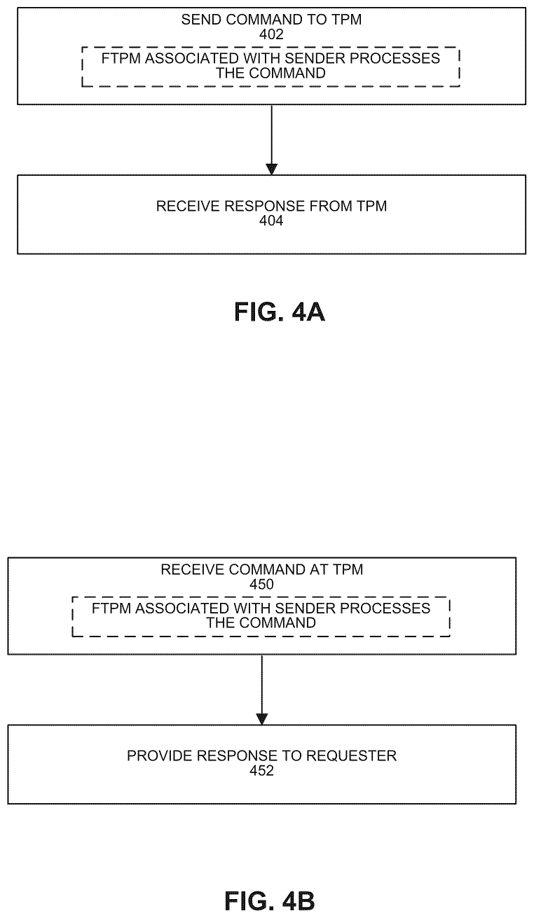

FIG. 4A depicts an example process. The process can be performed by a processor or other circuitry that accesses a TPM, in some examples. At 402, a command can be submitted to a TPM. In some examples, the TPM can be implemented as an fTPM or a process executed by a management controller or other circuitry. The command can be transmitted as an encrypted message from the processor to the management controller or other circuitry. Examples of commands can include: authorize a TPM operation on an object whose authorization is bound to a specific signing authority (e.g., unsealing a secret only when a signature is verified to be generated by a signing authority), unsealing secret only when a signature, hash, or digest of a memory region or system firmware or software measurements and stored in Platform Configuration Registers (PCR) match expected values to ensure that the firmware or software has not been modified, access to the credential qualifier to recover the credential secret, prove that an object is loaded in the TPM, attest the association between a loaded public area and the provided hash of the creation data, generate partial X509 certificate, change authorization values for TPM objects, replace the active endorsement primary seed with a new one generated off the TPM random number generator (RNG), validate a quote provided by a TPM, clear lockout endorsement and owner hierarchy authorization values and other TPM data, unblock lockout authorization handle for issuing TPM clear, set the clock rate period on the TPM, perform the part of an ECC anonymous signing operation, create a child object, generate attestation key with given algorithm under the endorsement hierarchy, generate TCG profile compliant endorsement key, create simple assertion authorization policies based on multiple PCR indices values across multiple enabled banks, create a primary key, setup or clear dictionary-attack-lockout parameters, duplicate a loaded object so that it may be used in a different hierarchy, create an ephemeral key and uses it to generate the shared secret value using the parameters from a Elliptic Curve Cryptography (ECC) public key, recover the shared secret value (Z) from a public point and a specified private key, or others. Other examples can be described with respect to Trusted Computing Group (TCG) “Trusted Platform Module Library Specification, Family 2.0, Level 00, Revision 01.83 (March 2024), as well as earlier and later versions or variations thereof.

At 404, the TPM can provide a response to the command. Responses can include response codes that indicate whether a command succeeded for failed with a specific reason. The response can be transmitted as an encrypted message from the management controller to the processor. Other examples can be described with respect to Trusted Computing Group (TCG) “Trusted Platform Module Library Part 2: Structures” Family 2.0 Level 00 Revision 00.99(October 2013), as well as earlier and later versions or variations thereof.

FIG. 4B depicts an example process. The process can be performed by a firmware TPM, in some examples. At 450, the TPM can receive a command. In some examples, the TPM can be implemented as an fTPM or a process executed by a management controller or other circuitry. The command can be transmitted as an encrypted message from the processor to the management controller or other circuitry. Various examples of commands are described herein. At 452, the TPM can provide responses to the commands. The response can be transmitted as an encrypted message from the management controller to the processor. Various examples of responses are described herein.

FIG. 5 depicts a system. In some examples, one or more circuitry of system 500 (e.g., processors 510, graphics 540, accelerators 542, or others) can be configured to access management controller 544 or other circuitry to access a firmware TPM, as described herein. System 500 includes processor 510, which provides processing, operation management, and execution of instructions for system 500. Processor 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 510 can include multiple processors and multiple processors can be embodied as processor sockets.

In one example, system 500 includes interface 512 coupled to processor 510, which can represent a higher speed interface or a high throughput interface for system components, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a programmable or fixed function offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit, single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Management controller 544 can implement multiple TPM instances as firmware such as one firmware TPM instance for a particular compute node. Management controller 544 can perform management and monitoring capabilities for system administrators or orchestrators to manage and monitor operation of system 500.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random-access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

Applications 534 and/or processes 536 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 532 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and drivers can execute on a processor sold or designed by Intel®, ARM®, AMD®, Qualcomm®, IBM®, Nvidia®, Broadcom®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers, workstations, or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. In some examples, packet processing device or network interface device 550 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 500 includes one or more input/output (I/O) interface(s) 560. I/O interface 560 can include one or more interface components through which a user interacts with system 500. Peripheral interface 570 can include any hardware interface not specifically mentioned above. Peripherals refer generally to devices that connect dependently to system 500.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example, controller 582 is a physical part of interface 514 or processor 510 or can include circuits or logic in both processor 510 and interface 514.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 500 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 500 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor devices, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples and includes an apparatus comprising: multiple processors and circuitry coupled to the multiple processors, wherein at least one of the multiple processors comprises multiple cores and wherein the circuitry is to provide the multiple processors with access to multiple associated firmware Trusted Platform Module (TPM) instances.

Example 2 includes one or more examples, wherein at least one firmware TPM instance of the firmware TPM instances is to apply cryptography to store information for platform authentication and wherein the information for platform authentication comprises one or more of: user credentials, passwords, certificates, encryption keys, shared secrets, state information, or hash data.

Example 3 includes one or more examples, wherein at least one firmware TPM instance of the firmware TPM instances is to execute in an isolated trusted execution environment.

Example 4 includes one or more examples, wherein the firmware TPM instance executing in an isolated trusted execution environment is to store state that is separate from the multiple processors.

Example 5 includes one or more examples, wherein the circuitry comprises a management controller and/or a network interface device.

Example 6 includes one or more examples, wherein the circuitry comprises a non-volatile random-access memory (NVRAM) to store information for platform authentication accessed by at least one of the firmware TPM instances.

Example 7 includes one or more examples, wherein the multiple processors are to communicate with associated firmware TPM instances by authenticated and encrypted communications.

Example 8 includes one or more examples, wherein a processor of the multiple processors is to command an associated firmware TPM instance of the firmware TPM instances and wherein the command comprises unsealing a secret if a signature is verified to be generated by a signing authority or unsealing a secret if a signature, hash, or digest of a memory region or system firmware or software measurements match expected values.

Example 9 includes one or more examples, wherein at least one of the multiple processors comprise one or more of: a core, a graphics processing unit (GPU), a field programmable gate array (FPGA), or a network interface device.

Example 10 includes one or more examples, and includes a method comprising: multiple processors accessing a connection to multiple interfaces and/or devices by communication with a Baseboard Management Controller (BMC), wherein the BMC is configurable to provide access to firmware TPM instances to at least two of the multiple processors.

Example 11 includes one or more examples, wherein the BMC comprises a non-volatile random-access memory (NVRAM) to store and output platform authentication data, platform measurements, passwords, certificates, or encryption keys for the firmware TPM instances.

Example 12 includes one or more examples, wherein the connection comprises one or more of: a bus, a fabric, or a mesh.

Example 13 includes one or more examples, wherein the firmware TPM instances execute in separate trusted execution environments.

Example 14 includes one or more examples, wherein the BMC is configurable to provide a number of TPM firmware instances based on the number of processors.

Example 15 includes one or more examples, wherein the communication between the firmware TPM instances and at least two of the multiple processors is authenticated and encrypted according to Distributed Management Task Force (DMTF) Security Protocol and Data Model (SPDM) standard.

Example 16 includes one or more examples, and includes at least one non-transitory computer-readable medium comprising instructions stored thereon, that if executed by one or more processors, cause the one or more processors to: execute firmware Trusted Platform Module (TPM) instances for multiple associated devices and provide communication between a firmware TPM instance of the firmware TPM instances and an associated multi-core processors to provide the multi-core processors with access to platform information.

Example 17 includes one or more examples, wherein at least one of the firmware TPM instances is to apply cryptography to store information for platform authentication.

Example 18 includes one or more examples, wherein the information for platform authentication comprises one or more of: user credentials, passwords, certificates, encryption keys, shared secrets, state information, or hash data.

Example 19 includes one or more examples, wherein at least one of the firmware TPM instances is to execute in an isolated trusted execution environment.

Example 20 includes one or more examples, wherein a device of the multiple devices is to command an associated firmware TPM instance of the firmware TPM instances and wherein the command comprises unsealing a secret if a signature is verified to be generated by a signing authority or unsealing a secret if a signature, hash, or digest of a memory region or system firmware or software measurements match expected values.

1. An apparatus comprising:
multiple processors and
circuitry coupled to the multiple processors, wherein at least one of the multiple processors comprises multiple cores and wherein the circuitry is to provide the multiple processors with access to multiple associated firmware Trusted Platform Module (TPM) instances.

2. The apparatus of claim 1, wherein the multiple firmware TPM instances apply cryptography to store information for platform authentication and wherein the information for platform authentication comprises one or more of: user credentials, passwords, certificates, encryption keys, shared secrets, state information, or hash data.

3. The apparatus of claim 1, wherein at least one firmware TPM instance of the firmware TPM instances is to execute in an isolated trusted execution environment.

4. The apparatus of claim 3, wherein the firmware TPM instance executing in an isolated trusted execution environment is to store state that is separate from the multiple processors.

5. The apparatus of claim 1, wherein the circuitry comprises a management controller and/or a network interface device.

6. The apparatus of claim 1, wherein the circuitry comprises a non-volatile random-access memory (NVRAM) to store information for platform authentication accessed by at least one of the firmware TPM instances.

7. The apparatus of claim 1, wherein the multiple processors are to communicate with associated firmware TPM instances by authenticated and encrypted communications.

8. The apparatus of claim 1, wherein a processor of the multiple processors is to command an associated firmware TPM instance of the firmware TPM instances and wherein the command comprises unsealing a secret if a signature is verified to be generated by a signing authority or unsealing a secret if a signature, hash, or digest of a memory region or system firmware or software measurements match expected values.

9. The apparatus of claim 1, wherein at least one of the multiple processors comprise one or more of: a core, a graphics processing unit (GPU), a field programmable gate array (FPGA), or a network interface device.

10. A method comprising:
multiple processors accessing a connection to multiple interfaces and/or devices by communication with a Baseboard Management Controller (BMC), wherein the BMC is configurable to provide access to multiple firmware TPM instances to at least two of the multiple processors.

11. The method of claim 10, wherein the BMC comprises a non-volatile random-access memory (NVRAM) to store and output platform authentication data, platform measurements, passwords, certificates, or encryption keys for the firmware TPM instances.

12. The method of claim 10, wherein the connection comprises one or more of: a bus, a fabric, or a mesh.

13. The method of claim 10, wherein the firmware TPM instances execute in separate trusted execution environments.

14. The method of claim 10, wherein the BMC is configurable to provide a number of TPM firmware instances based on the number of processors.

15. The method of claim 10, wherein the communication between the firmware TPM instances and at least two of the multiple processors is authenticated and encrypted according to Distributed Management Task Force (DMTF) Security Protocol and Data Model (SPDM) standard.

16. At least one non-transitory computer-readable medium comprising instructions stored thereon, that if executed by one or more processors, cause the one or more processors to:
execute multiple firmware Trusted Platform Module (TPM) instances for multiple associated devices and
provide communication between a firmware TPM instance of the firmware TPM instances and an associated multi-core processors to provide the multi-core processors with access to platform information.

17. The at least one non-transitory computer-readable medium of claim 16, wherein at least one of the firmware TPM instances is to apply cryptography to store information for platform authentication.

18. The at least one non-transitory computer-readable medium of claim 16, wherein the information for platform authentication comprises one or more of: user credentials, passwords, certificates, encryption keys, shared secrets, state information, or hash data.

19. The at least one non-transitory computer-readable medium of claim 16, wherein at least one of the firmware TPM instances is to execute in an isolated trusted execution environment.

20. The at least one non-transitory computer-readable medium of claim 16, wherein a device of the multiple devices is to command an associated firmware TPM instance of the firmware TPM instances and wherein the command comprises unsealing a secret if a signature is verified to be generated by a signing authority or unsealing a secret if a signature, hash, or digest of a memory region or system firmware or software measurements match expected values.
